(19) United States
(12) Patent Application Publication
(10) Pub. No.: US 2017/0046552 A1
(43) Pub. Date: Feb. 16, 2017

(54) INTELLIGENT COMPONENT AND INTELLIGENT BICYCLE

(71) Applicants: Le Holdings (Beijing) Co., Ltd., Beijing (CN); LETV SPORTS CULTURE DEVELOP (BEIJING) CO., LTD., Beijing (CN)

(72) Inventor: Dalong Li, Beijing (CN)

(73) Assignees: Le Holdings (Beijing) Co., Ltd., Beijing (CN); LETV SPORTS CULTURE DEVELOP (BEIJING) CO., LTD., Beijing (CN)

(21) Appl. No.: 15/250,291

(22) Filed: Aug. 29, 2016

Related U.S. Application Data
(63) Continuation of application No. PCT/CN2016/082090, filed on May 13, 2016.

(30) Foreign Application Priority Data
Aug. 11, 2015 (CN) 201510491526.9

(51) Int. Cl. G06K 9/00; B62J 99/00; G06F 3/041

(52) U.S. Cl. CPC G06K 9/0002; G06F 3/041; B62J 99/00; B62J 2099/0026; B62J 2300/0013

(57) ABSTRACT

The application provides an intelligent component and an intelligent bicycle. The intelligent component includes a bracket, and an intelligent component body embedded on the bracket, wherein the bracket is connected between a handle bar of an intelligent bicycle, and a frame of the intelligent bicycle; and the intelligent component body includes a touch screen and fingerprint sensors, wherein an accommodating groove in which the fingerprint sensors are arranged is arranged on the lower surface of the touch screen. This technical solution can perform privileged management on the intelligent component or the intelligent bicycle using a fingerprint password to thereby improve the security of managing the intelligent bicycle, and to lower the troublesomeness of unlocking the intelligent bicycle.

This application is a US National Stage of International Application PCT/CN2016/082090, filed on May 13, 2016, designating the United States, and claiming the benefit of Chinese Patent Application No. 201510491526.9, filed with the Chinese Patent Office on Aug. 11, 2015 and entitled “Intelligent component and intelligent bicycle”, which is hereby incorporated by reference in its entirety.

### TECHNICAL FIELD

The present application relates to the field of bicycles, and particularly to an intelligent component and an intelligent bicycle.

### BACKGROUND

Bicycles today have been used as more than transportation means, and people prefer to enjoy more while they are exercising in an environmentally friendly manner by riding their bicycles as their level of life has been increasingly growing, so intelligent bicycles have emerged in response to this demand.

The inventors of this application have designed an intelligent bicycle including an intelligent component with which a user can play music, navigate, manage and control the bicycle, and perform other operations. There is such a technical problem highly desirable to address how to perform privileged management on the intelligent component or the intelligent bicycle so as to improve the security of management on the intelligent bicycle and to lower the troublesomeness of unlocking the intelligent bicycle.

### SUMMARY

Embodiments of the application provide an intelligent component and an intelligent bicycle on which privileged management is performed using a fingerprint password so as to improve the security of management on the intelligent bicycle and to lower the troublesomeness of unlocking the intelligent bicycle.

An embodiment of the application provides an intelligent component including a bracket, and an intelligent component body embedded on the bracket, wherein the bracket is connected between a handle bar of an intelligent bicycle, and a frame of the intelligent bicycle; and the intelligent component body includes a touch screen and fingerprint sensors, wherein an accommodating groove in which the fingerprint sensors are arranged is arranged on the lower surface of the touch screen.

In the technical solution according to the embodiment of the application, the intelligent component includes the fingerprint sensors, and with the intelligent component structured as such, privileged management can be performed on the intelligent component or the intelligent bicycle by setting a fingerprint password which is more secured than another type of password to thereby greatly improve the security of managing the intelligent bicycle; and the fingerprint password can make it more convenient to unlock the intelligent bicycle than a digital password or another type of password. Furthermore the fingerprint sensors can be arranged in the accommodating groove of the touch screen to thereby shorten the distances between a finger and the fingerprint sensors so as to improve the sensitivity and the recognition efficiency of the sensors; and the outer surface of the touch screen can be structured integral and smooth to thereby be protected from water and dust.

An embodiment of the application further provides an intelligent bicycle including a frame and a handle bar, and the intelligent component according to any one of the technical solutions above.

With the intelligent bicycle according to the embodiment of the application, privileged management can be performed on the intelligent bicycle by setting in a display area on the intelligent component a fingerprint password which is more secured than another type of password to thereby greatly improve the security of managing the intelligent bicycle; and the fingerprint password can make it more convenient to unlock the intelligent bicycle than a digital password or another type of password.

### BRIEF DESCRIPTION OF THE DRAWINGS

In order to make the technical solutions according to the embodiments of the application or in the prior art more apparent, the drawings to which a description of the embodiments or the prior art refers will be briefly introduced below, and apparently the drawings to be described below are merely illustrative of some of the embodiments of the application, and those skilled in the art can derive from these drawings other drawings without any inventive effort. In the drawings:

FIG. 1 is a schematic explosive structural diagram of an intelligent component according to an embodiment of the application;

FIG. 2 is a front view of a touch screen of an intelligent component according to an embodiment of the application;

FIG. 3 is a back view of a touch screen of an intelligent component according to an embodiment of the application; and

FIG. 4 is a schematic structural diagram of a cross section along A-A in FIG. 2.

### REFERENCE NUMERALS

| | |
|---|---|
| 1-Intelligent component | 10-Bracket |
| 20-Intelligent component body | 21-Touch screen |
| 22-Display screen | 23-Upper casing |
| 24-Circuit board and battery | 25-Lower casing |
| 210-Fingerprint sensor | 211-GPS antenna module |
| 212-Light sensitive module | 213-First connector |
| 214-Second connector | 215-Accommodating groove |

### DESCRIPTION OF THE EMBODIMENTS

In order to make the objects, technical solutions, and advantages of the embodiments of the application more apparent, the technical solutions according to the embodiments of the application will be described below clearly and fully with reference to the drawings in the embodiments of the application, and apparently the embodiments described below are only a part but not all of the embodiments of the application. Based upon the embodiments here of the application, all the other embodiments which can occur to those skilled in the art without any inventive effort shall fall into the scope of the application.

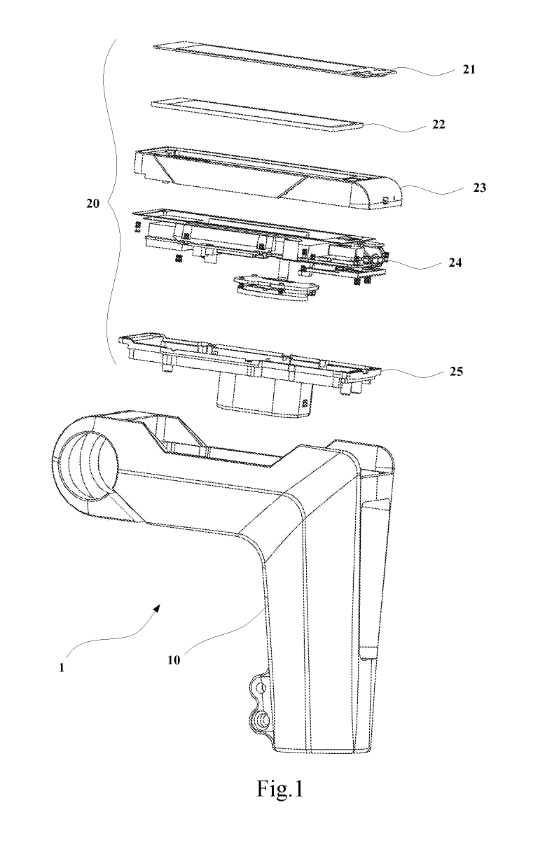

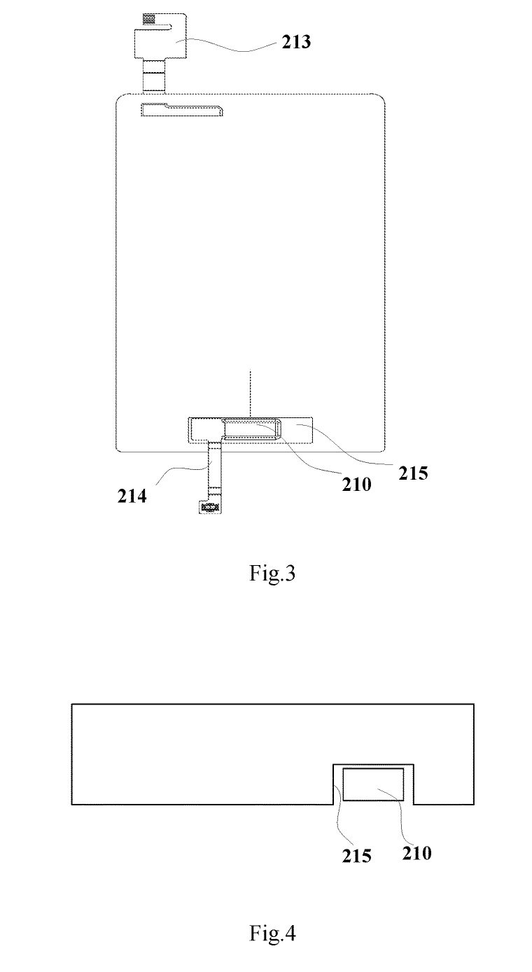

As illustrated in FIG. 1 to FIG. 3, an intelligent component 1 according to an embodiment of the application includes a bracket 10, and an intelligent component body 20 embedded on the bracket 10, where the bracket 10 is connected between a handle bar of an intelligent bicycle and a frame of the intelligent bicycle; and the intelligent component body 20 includes a touch screen 21 and fingerprint sensors 210, where an accommodating groove 215 in which the fingerprint sensors 210 are arranged is arranged on the lower surface of the touch screen 21.

In the technical solution according to the embodiment of the application, the intelligent component 20 includes the fingerprint sensors 210, and with the intelligent component 1 structured as such, privileged management can be performed on the intelligent component 1 or the intelligent bicycle by setting a fingerprint password which is more secured than another type of password to thereby greatly improve the security of managing the intelligent bicycle; and the fingerprint password can make it more convenient to unlock the intelligent bicycle than a digital password or another type of password. Furthermore the fingerprint sensors 210 can be arranged in the accommodating groove 215 of the touch screen 21 to thereby shorten the distances between a finger and the fingerprint sensors 210 so as to improve the sensitivity and the recognition efficiency of the sensors; and the outer surface of the touch screen 21 can be structured integral and smooth to thereby be protected from water and dust.

As illustrated in FIG. 1, the intelligent component body 20 includes a lower casing 25, a circuit board and battery 24, an upper casing 23, a display screen 22, and a touch screen 21 arranged in that order from the inside to the outside, where the lower casing 25 is connected with the bracket 10, the upper casing 23 is connected with the lower casing 25, and the circuit board and battery 24 is located in a holding space defined by the lower casing 251 and the upper casing 23; and the display screen 22 and the touch screen 21 are arranged on the outer surface of the upper casing 23.

In a preferred embodiment of the application, the fingerprint sensors 210 are arranged on the side of the touch screen 21 away from the handle bar so that a user can unlock the intelligent component conveniently to thereby lower the operational troublesomeness.

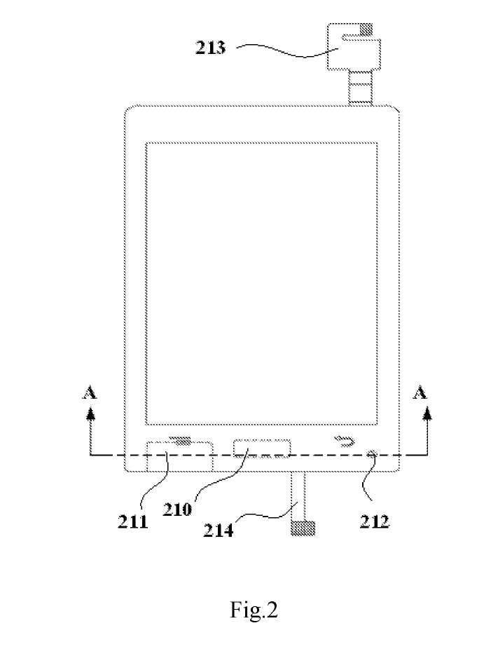

In the embodiments illustrated in FIG. 2 to FIG. 4, the accommodating groove 215 is located on the side of the touch screen 21 away from the handle bar, the fingerprint sensors 210 are arranged in the accommodating groove 215 of the touch screen 21, a light sensitive module 212 and a GPS antenna module 211 are further arranged on the side of the intelligent component body 20 away from the handle bar, and the touch screen 21 is preferably made of another material than metal in an area thereof corresponding to the GPS antenna module 211. The touch screen 21 further includes a first connector 213 and a second connector 214 connected with the circuit board and battery 24 of the intelligent component for signal transmission.

The fingerprint sensors can be optical fingerprint sensors or semiconductor fingerprint sensors, where under the refraction and reflection principles of light, the optical fingerprint sensors are configured to have a finger placed over a fingerprint sensing area of the touch screen so that the finger is illuminated by light sources built in the touch screen, and light is transmitted from the bottom to a triangular prism and transmitted from the triangular prism, where the transmitted light rays are refracted at different angles and reflected back at different brightness on uneven lines of the fingerprint on the surface of the finger, and projected by the prism onto charge coupled devices, thus resulting in a digitalized multi-grayscale fingerprint image which can be processed algorithmically by a fingerprint recognizer to recognize the fingerprint; and the semiconductor fingerprint sensors may be capacitive semiconductor fingerprint sensors or inductive semiconductor fingerprint sensors, where the finger is placed on the fingerprint sensors in which semiconductor elements are distributed, to form therewith capacitors or inductors, and different capacitances or inductances are generated as a function of different distances between uneven lines of the fingerprint on the surface of the finger, and the finger print sensors, thus acquiring the fingerprint.

An embodiment of the application provides an intelligent bicycle including a frame and a handle bar, and the intelligent component according to any one of the technical solutions above. With the intelligent bicycle according to the embodiment of the application, privileged management can be performed on the intelligent bicycle by setting in a display area on the intelligent component a fingerprint password which is more secured than another type of password to thereby greatly improve the security of managing the intelligent bicycle; and the fingerprint password can make it more convenient to unlock the intelligent bicycle than a digital password or another type of password.

Lastly it shall be noted that the respective embodiments above are merely intended to illustrate but not to limit the technical solution of the application; and although the application has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the application as claimed.

1. An intelligent component, comprising a bracket, and an intelligent component body embedded on the bracket, wherein the bracket is connected between a handle bar of an intelligent bicycle and a frame of the intelligent bicycle; and the intelligent component body comprises a touch screen and fingerprint sensors, wherein an accommodating groove in which the fingerprint sensors are arranged is arranged on the lower surface of the touch screen.

2. The intelligent component according to claim 1, wherein the intelligent component body further comprises a lower casing, a circuit board and battery, an upper casing, a display screen, and a touch screen arranged in that order from the inside to the outside, wherein:
the lower casing is connected with the bracket, the upper casing is connected with the lower casing, and the circuit board and battery is located in a holding space defined by the lower casing and the upper casing; and the display screen and the touch screen are arranged on the outer surface of the upper casing.

3. The intelligent component according to claim 1, wherein the accommodating groove is located on the side of the touch screen away from the handle bar.

4. The intelligent component according to claim 1, wherein a light sensitive module and a GPS antenna module are further arranged on the side of the intelligent component body away from the handle bar.

5. The intelligent component according to claim 1, wherein the fingerprint sensors are optical fingerprint sensors or semiconductor fingerprint sensors.

6. An intelligent bicycle, comprising a frame and a handle bar, and an intelligent component;
wherein the intelligent component comprise a bracket, and an intelligent component body embedded on the bracket, wherein the bracket is connected between the handle bar of the intelligent bicycle and the frame of the intelligent bicycle; and the intelligent component body comprises a touch screen and fingerprint sensors, wherein an accommodating groove in which the fingerprint sensors are arranged is arranged on the lower surface of the touch screen.

7. The intelligent component according to claim 2, wherein the fingerprint sensors are optical fingerprint sensors or semiconductor fingerprint sensors.

8. The intelligent component according to claim 3, wherein the fingerprint sensors are optical fingerprint sensors or semiconductor fingerprint sensors.

9. The intelligent component according to claim 4, wherein the fingerprint sensors are optical fingerprint sensors or semiconductor fingerprint sensors.

10. The intelligent bicycle according to 6, wherein the intelligent component body further comprises a lower casing, a circuit board and battery, an upper casing, a display screen, and a touch screen arranged in that order from the inside to the outside, wherein:
the lower casing is connected with the bracket, the upper casing is connected with the lower casing, and the circuit board and battery is located in a holding space defined by the lower casing and the upper casing; and the display screen and the touch screen are arranged on the outer surface of the upper casing.

11. The intelligent bicycle according to 6, wherein the accommodating groove is located on the side of the touch screen away from the handle bar.

12. The intelligent bicycle according to 6, wherein a light sensitive module and a GPS antenna module are further arranged on the side of the intelligent component body away from the handle bar.

13. The intelligent bicycle according to 6, wherein the fingerprint sensors are optical fingerprint sensors or semiconductor fingerprint sensors.

14. The intelligent bicycle according to 10, wherein the fingerprint sensors are optical fingerprint sensors or semiconductor fingerprint sensors.

15. The intelligent bicycle according to 11, wherein the fingerprint sensors are optical fingerprint sensors or semiconductor fingerprint sensors.

16. The intelligent bicycle according to 12, wherein the fingerprint sensors are optical fingerprint sensors or semiconductor fingerprint sensors.
